(19) United States
(12) Patent Application Publication
(10) Pub. No.: US 2011/0219730 A1
(43) Pub. Date: Sep. 15, 2011

(54) Concentrated fabric softener active compositions

(76) Inventors: Alessandro Corona, III, Mason, OH (US); Mark Robert Sivik, Mason, OH (US); Leonard Frank Zaporowski, Chicago, IL (US)

(21) Appl. No.: 13/068,625

(22) Filed: May 16, 2011

Related U.S. Application Data
(63) Continuation of application No. 11/511,591, filed on Aug. 29, 2006, now abandoned.
(60) Provisional application No. 60/713,016, filed on Aug. 31, 2005.

(51) Int. Cl. B65B 1/04; C11D 3/60

(52) U.S. Cl. 53/467; 510/515

(57) ABSTRACT

A composition for softening fabric is provided.

### CROSS REFERENCES TO RELATED APPLICATIONS

This application is a continuation of and claims priority under 35 USC §120 to U.S. patent application Ser. No. 11/511,591, filed Aug. 29, 2006, which in turn claims the benefit of U.S. Provisional Application No. 60/713,016, filed Aug. 31, 2005.

### FIELD OF INVENTION

The present invention relates to fabric care compositions and methods of using and making the same.

### BACKGROUND OF THE INVENTION

A typical laundry process consists of a user washing laundry with a detersive surfactant and thereafter rinsing the laundry multiple times before a final rinse step where a fabric softener is added. Conventional rinse-added fabric softeners are well known. These conventional softeners are typically added to the final rinse, i.e., typically with at least one intermediate rinse before the final rinse to remove any surfactant carryover as result of washing the laundry. However, these conventional rinse-added fabric softener are inconvenient, particularly to those who hand wash their laundry, given that multiple rinses are required.

More recently, fabric softeners for use in a first or single rinse have been reported. US 2003/0060390 A1. One example of such a commercial product includes DOWNY® Single Rinse. Such compositions provide the benefit of softening laundry and rinsing the fabric in one step. The compositions provide convenience by saving the user from multiple rinse steps. Avoiding these additional rinse steps saves the user time and helps the environment by conserving the use of water. Such compositions are particularly useful for those who hand wash their laundry saving the user labor intensive rinse steps.

However, a problem with these compositions is their affordability, particularly in those new or developing markets that are typically characterized by those users that generally hand wash their laundry. Fabric softeners typically require large capital investments. These large capital investments are often cost prohibitive for a manufacturer to enter a new market. Therefore there is a need to provide a fabric care composition that does not require large capital investment to be manufactured in the new or developing market.

One way to save capital costs in a new market is to produce the product at a remote facility and then transport the product into the new market. However, many fabric softeners comprise a substantial amount of water. As such, it is typically too cost prohibitive to ship these fabric softeners to the developing market.

Another way to save capital costs in a new market is to provide a concentrated form of the fabric softener that is manufactured at remote facility and then transported to the new market to be later hydrated to a final product. However, many of these concentrated forms of the fabric softener in their concentrated state or use solvents that are flammable or even explosive thereby requiring special containers or handling care when being shipped. These flammable or explosive compositions may also pose regulatory hurdles when being shipped. Other concentrated forms are in a hot molten state that require heating elements to keep the concentrate in its molten state or require heating to the concentrate at the point of destination to remove the concentrate its transportation container. These extra measures again can be cost prohibitive to a manufacturer when entering a new market.

Therefore there is a need to provide a concentrated fabric softener that can be shipped safely from a remote facility to a new market safely and economically. There is also a need for a concentrated fabric softener to be easily hydrated with low, if any, capital investment in the new market. There is also a need for the concentrated fabric softener composition to be hydrated to an effective single rinse fabric care composition.

### SUMMARY OF THE INVENTION

One aspect of the invention provides a concentrated fabric softening composition (“CFSC”) comprising from about 60% to about 98% of a fabric softening active (“FSA”) and a diluent; wherein the FSA comprises a quaternary ammonium compound, wherein the quaternary ammonium compound comprises a monoester and a diester, wherein the monester comprises from about 10% to about 50% by the total FSA weight; and wherein the diester comprises from about 15% to about 80% by the total FSA weight; wherein the diluent provides the CFSC to have a 80% of its melting enthalpy above about 40° C. as determined by a differential scanning calorimetry; wherein the concentrated softening composition comprises less than 6% water by weight of the CFSC.

A second aspect of the invention provides a method of making a fabric care composition comprising the steps: (a) manufacturing a concentrated fabric softening composition (CFSC) in a first site, wherein the CFSC comprises a flashpoint above 100° C.; (b) containing the CFSC in a container; wherein no heat is applied to the CFSC contained in the container; (c) transporting the container containing the CFSC to a second site.

A third aspect of the invention provides a CFSC comprising: (a) from about 75% to about 98% of a fabric softening active by weight of the CFSC; (b) from about 0.05% to about 15% glycerin or a glycerin derivative by weight of the CFSC; (c) from about 6% to about 10% of a triglyceride by weight of the CFSC; (d) less than 1% water by weight of the CFSC; (e) free of adjunct ingredients.

### DETAILED DESCRIPTION OF THE INVENTION

### I. CONCENTRATED FABRIC SOFTENER COMPOSITION (CFSC)

A first aspect of the invention provides a concentrated fabric softener composition (hereinafter “CFSC”) comprising a fabric softener active (hereinafter “FSA”) and a diluent. In one embodiment of the invention, the CFSC is free or essentially free of water. In another embodiment, the CFSC comprises a coupling agent. In yet another embodiment, the CFSC is free or essentially free of adjunct ingredients. Non-limiting examples of an adjunct ingredient includes a perfume, dye, suds suppressor, or mixture thereof.

Another aspect of the invention provides for a method of making a fabric softener composition comprising the step of adding water to a CFSC of the present invention. In one embodiment, the method further comprises the step of adding one or more adjunct ingredients. In one embodiment, the fabric softener composition is a single rinse fabric softener composition.

### A. FSA

In one embodiment of the invention, the FSA is a quaternary ammonium compound suitable for softening fabric in a rinse step. In one embodiment, the FSA is formed from a reaction product of a fatty acid and an aminoalcohol obtaining mixtures of mono-, di-, and, in one embodiment, triester compounds. In another embodiment, the FSA comprises one or more softener quaternary ammonium compounds such, but not limited to, as a monoalkyquaternary ammonium compound, a diamido quaternary compound and a diester quaternary ammonium compound, or a combination thereof.

In one aspect of the invention, the FSA comprises a diester quaternary ammonium (hereinafter “DQA”) compound composition. In certain embodiments of the present invention, the DQA compounds compositions also encompasses a description of diamido FSAs and FSAs with mixed amido and ester linkages as well as the aforementioned diester linkages, all herein referred to as DQA.

A first type of DQA (“DQA (1)”) suitable as a FSA in the present CFSC includes a compound comprising the formula:

{R₄₋ₘ—N⁺—[(CH₂)ₙ—Y—R¹]ₘ}X⁻

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., tallow, hardended tallow, oleic acid, and/or partially hydrogenated fatty acids, derived from vegetable oils and/or partially hydrogenated vegetable oils, such as, canola oil, safflower oil, peanut oil, sunflower oil, corn oil, soybean oil, tall oil, rice bran oil, palm oil, etc. Non-limiting examples of suitable fatty acids are listed in U.S. Pat. No. 5,759,990 at column 4, lines 45-66. In one embodiment the FSA comprises other actives in addition to DQA (1) or DQA. In yet another embodiment, the FSA comprises only DQA (1) or DQA and is free or essentially free of any other quaternary ammonium compounds or other actives. In yet another embodiment, the FSA comprises the precursor amine that is used to produce the DQA.

In another aspect of the invention, the FSA comprises a compound, identified as DTTMAC comprising the formula:

[R₄₋ₘ—N⁽⁺⁾—R¹ₘ]A⁻

wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branch or unbranched. In one embodiment, the Iodine Value (IV) of the FSA is from about 1 to 70; each R is H or a short chain C₁-C₆, preferably C₁-C₃ alkyl or hydroxyalkyl group, e.g., methyl (most preferred), ethyl, propyl, hydroxyethyl, and the like, benzyl, or (R²O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these FSAs include dialkydimethylammonium salts and dialkylenedimethylammonium salts such as ditallowdimethylammonium and ditallowdimethylammonium methylsulfate. Examples of commercially available dialkylenedimethylammonium salts usable in the present invention are di-hydrogenated tallow dimethyl ammonium chloride and ditallowdimethyl ammonium chloride available from Degussa under the trade names Adogen® 442 and Adogen® 470 respectively. In one embodiment the FSA comprises other actives in addition to DTTMAC. In yet another embodiment, the FSA comprises only compounds of the DTTMAC and is free or essentially free of any other quaternary ammonium compounds or other actives.

In one embodiment, the FSA comprises an FSA described in U.S. Pat. Pub. No. 2004/0204337 A1, published Oct. 14, 2004 to Corona et al., from paragraphs 30-79.

In another embodiment, the FSA is one described in U.S. Pat. Pub. No. 2004/0229769 A1, published Nov. 18, 2005, to Smith et al., on paragraphs 26-31; or U.S. Pat. No. 6,494,920, at column 1, line 51 et seq. detailing an “esterquat” or a quaternized fatty acid triethanolamine ester salt.

1. Monoester Level in the FSA

One aspect of the invention provides a monoester level, by weight, of at least about 10%, alternatively at least about 20%, alternatively at least about 30%; but not greater than about 50%, alternatively not greater than 40%, alternatively not greater than about 30%, by the total FSA weight. As used herein, the “total FSA weight” includes the mass encompassing all reaction products that comprise one or more R¹ and this weight is used to quantify the individual percentages of mono-, di-, and triester reaction products by dividing the individual masses of mono-, di-, and tri-ester by the hereinabove stated total FSA and multiplying this number by 100 to give a percentage of the total.

Without wishing to be bound by theory, the benefits of having a FSA comprising a monoester level as described herein include, but are not limited to, enhanced solubility of the FSA in water and/or a diluent of the present invention and/or a coupling agent of the present invention. Too much monoester content may provide a FSA that does not provide enough softening efficiency. A second benefit of the described monoester level may include a FSA that is exhibits resilience to anionic surfactant carry-over conditions. This is particularly true in those embodiments that the CFSC is made to a single rinse fabric softening composition. The term “anionic surfactant carrier-over” means the anionic surfactant that may be present either on the fabric or in the wash liquor during the wash cycle of the laundry process and that is carried over with the laundered fabrics into the rinse bath solution.

2. Diester Level in FSA

One aspect of the invention provides for a level of diester content, by weight, from about 15% to about 80% by the total FSA weight. This range of diester surprisingly balances enough of a softening benefit for the FSA yet allows for enough monoester content (and its associated benefits). Examples of diester comprising compounds of the present invention may include one or more of the following: N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available triethyloamine trietester quats suitable for the present invention include di-(hydrogenated tallowoyloxyethyl)-N,N-methylhydroxyethylammonium methylsulfate and di-(oleoyloxyethyl)-N,N-methylhydroxyethylammonium methylsulfate sold under the trade names Rewoquat® WE 15 and Varisoft® WE 16 , both available from Degussa.

3. Triester Level in FSA.

One aspect of the invention provides for a level of triester content in the FSA from about 0% to about 40% by the total FSA weight. Another aspect of the invention provides the FSA to be free or essentially free of a triester.

Those skilled in the art will recognize that the FSA of the present invention may comprise a combination of mono-, di-, and triesters depending on the process and the starting materials. In the present invention, wherein the CFSC is made into a single rinse fabric softening composition, it may be desirable to have the FSA comprise the following mole ratios of diester to monoester species; typically less than about 2 moles of diester to about 1 mole of monoester, alternatively less than 1.6 moles of diester to about 1 mole of monoester, alternatively about 1.3 mole of diester to about 1 mole of monoester, and alternatively more than 0.5 mole of diester for 1 mole of monoester, alternatively more than about 1 mole of diester for 1 mole of monoester.

In one embodiment, the FSA is chosen from at least one of the following: ditallowoyloxyethyl dimethyl ammonium chloride, dihydrogenated-tallowoyloxyethyl dimethyl ammonium chloride, ditallow dimethyl ammonium chloride, ditallowoyloxyethyl dimethyl ammonium methyl sulfate, dihydrogenated-tallowoyloxyethyl dimethyl ammonium chloride, dihydrogenated-tallowoyloxyethyl dimethyl ammonium chloride, or combinations thereof.

In one embodiment, the FSA may also include amide containing compound compositions. Examples of diamide comprising compounds may include but not limited to methyl-bis(tallowamidoethyl)-2-hydroxyethylammonium methyl sulfate (available from Degussa under the trade names Varisoft 110 and Varisoft 222). An example of an amide-ester containing compound is N-[3-(stearoylamino)propyl]-N-[2-(stearoyloxy)ethoxy)ethyl)]-N-methylamine.

In one embodiment, the FSA comprises, by weight, from: at least about 60%, alternatively at least about 70%, 75%, 80%, 85%, 90%, 95%, 97%, or 98%; alternatively not greater than about 98%, 97%, 95%, 90%, or 85%; by weight of the CFSC.

### II. DILUENT

One aspect of the invention provides a CFSC comprising a diluent, wherein the diluent is chosen from at least one of the following: an alkyl ester or polyester, an alkyl amide or polyamide, a fatty acid, nonionic, or combination thereof.

In one embodiment, the diluent comprises, on a weight basis, at least about 2%, alternatively at least about 3%, 5%, 7%, 8%, 10%, 15%, 20%, 25%, 30%, 35%, or 40%; but less than about 40%, alternatively less than about 35%, 30%, or 25%; by weight of the CFSC.

In one embodiment, the diluent of the present invention may reduce the viscosity of the reaction mixture in the final quaternization step of quaternizing the fatty ester amine with alkylating agent (e.g., methyl chloride, methyl sulfate, etc.) to make an FSA of the present invention. In a second embodiment, the diluent reduces the viscosity of the reaction mixture of at least two steps, alternatively at least three steps, alternatively at least four steps, in the process of making the CFSC. Without wishing to be bound by theory, this reduction in viscosity provides the benefit of avoiding phase separation and allowing the amine composition to be quaternized to more than 90% completion. Reduction in viscosity allows for efficient FSA production requiring less reaction time. The phrase “reducing the viscosity” of the reaction mixture means the viscosity of the reaction mixture is reduced to less than about 10,000 centipoise at a temperature of 90° C.; alternatively less than about 8,000, less than about 6,000, less than about 4,000, less than about 2,000 centipoise at 90° C. Processing viscosity may be determined using a Brookfield DV-III Type RV rheometer. The rheometer is outfitted with a small sample adapter and an SC4-28 spindle. The viscosity can be measured at 95° C. at 14 s⁻¹.

In one embodiment, the diluent is one that facilitates the CFSC to be formed in a flake, prill, powder, or pumpable fluid.

When the CFSC is in a solid form (e.g., flake, noodle, prill, etc.), the diluent is chosen such that the CFSC, wherein the CFSC comprises FSA and diluent, comprises from about 60% to about 90%, preferably about 80% to about 85% of its melting enthalpy is above 40° C. as determined by a differential scanning calorimetry (DSC). One suitable example of a DSC is using a Perkin-Elmer DSC-7 Differential Scanning calorimeter with the following parameters: tᵢₙᵢₜ at 0.00° C.; yᵢₙᵢₜ at 20.00 mW; purge gas is nitrogen; purge gas rate is 20.0 ml/min; sample rate is at the standard setting; pan type is aluminum. The procedure includes: 1) Holding for 3.0 min at 0.00° C.; 2) Heating from 0.00° C. to 90.00° C. at 5.00° C./min; 3) Holding for 3.0 min at 90.00° C.; and 4) Cooling from 90.00° C. to 0.00° C. at 5.00° C./min.

In another embodiment, the CFSC is in a solid form, the diluent is chosen such that CFSC comprises a peak melt temperature above 40° C., alternatively from about 40° C. to about 45° C., alternatively about 40.5° C. to about 42° C., as determined by DSC.

As used herein, the “peak melt temperature” means the temperature at which the largest amount of heat is required to continue raising the temperature at the desired rate.

The percent of enthalpy required to raise the temperature of the sample from 5° C. to 40° C. (% enthalpy <40° C.) is determined by dividing the amount of enthalpy required to heat the sample from about 5° C. to about 40° C. by the total enthalpy required to heat the sample from about 5° C. to about 85° C. This fraction is then multiplied by 100.

In one embodiment, the diluent chosen comprises a flashpoint greater than 100° C. preferably greater than 125° C. In another embodiment, the diluent comprises a flashpoint lower comprises 300° C. Suitable ways of determining flash point include using either a Tag Closed Tester (ASTM D-56-70) or Pensky-Martens Closed Tester (ASTM D-93-71). In another embodiment, the CFSC comprises a flashpoint greater than 125° C. preferably greater than 135° C. In another embodiment, the CFSC comprises a flashpoint lower than 325° C.

### A. Alkyl Esters and Polyesters

Alkyl ester and polyester diluents of the present invention have the formula:

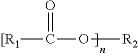

wherein R₁ and R
chosen from the group consisting of C₁-C₃₀, preferably C₁₀-C₂₂, straight, branched, or cyclic alkyl, alkenyl, alkynyl, or aryl group, and represents the group attached to the carboxylate function of the carboxylic acid to make a fatty ester compound. Each R₂ is an alcohol derivative is independently selected from C₁-C₆₀ mono, di, tri, tetra, penta, oligo, or polyol; saturated or unsaturated, substituted or unsubstituted, straight, branched, cyclic, including heterocyclic aliphatic group; or mono, poly, or heterocyclic aromatic group.

The term “polyol” is intended to include any linear, cyclic, or aromatic compound containing at least two esterifiable hydroxyl groups. Polyols suitable herein include, but are not limited to, glycol, glycerol, pentaerythritol, sucrose, mannose, galactose, arabinose, xylose, ribose, fructose, sorbose, erythrulose, sorbitol, mannitol, galactitol, xylitol, maltose, cellobiose, lactose, trehalose and raffinose.

Preferred esters and polyesters used in the present invention are free or essentially free of polyhydric alcohol to the extent that the free polyhydric alcohol content is less than 10% and preferably less than 5% of the alkyl ester or polyester diluent composition.

### B. Alkyl Amides and Polyamides:

Alkyl amide and polyamide diluents of the present invention have the formula:

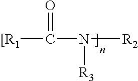

wherein R₁, R₂, and R₃ are described hereinafter and n is an integer of 1 or greater. R₁ is selected from the group consisting of C₁-C₃₀, preferably C₁₀-C₂₂, straight, branched, or cyclic alkyl, alkenyl, alkynyl, or aryl group, and represents the group attached to the carboxylate function of the amide to make a fatty amide compound. Each R₂ and R₃ comprise an amine derivative independently selected from C₁-C₃₀, straight, branched or cyclic, substituted or unsubstituted alkyl, alkenyl, alkynyl, or aryl group, mono, di, tri, tetra, penta, oligo, or polyamine.

Preferred amides and polyamides used in the present invention are substantially free of amine to the extent that the free amine content is less than 10% and preferably less than 5% of the amide or polyamide diluent composition.

### C. Fatty Acid

In a third embodiment, the diluent comprises a fatty acid comprising the formula:

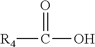

wherein R₄ is selected from C₁-C₃₀, preferably C₁₀-C₂₂, straight, branched, or cyclic alkyl, alkenyl, alkynyl, or aryl groups.

### D. Specific Examples of Diluents

In a fourth embodiment, the diluent is chosen from but not limited to one of the following: hydrogenated tallow fat (Edible Hydrogenated Tallow produced by Ed Miniat), hydrogenated tallow fatty acid (T-1 Fatty Acid produced by Twin Rivers), hydrogenated coconut oil, hydrogenated palm stearine, hydrogenated soy oil, ethylene glycol distearate (Stepan EGDS), hard soy sucrose ester (Procter & Gamble Sefose 1618H), cetyl palmitate (Stepan 653), pentaerythritol tetracaprylate/tetracaprate (Stepan PTC).

In one embodiment, the diluent comprises urea. In yet another embodiment, the diluent is free or essentially free of urea.

### E. Compounds Excluded as Diluents.

In a fifth embodiment, notwithstanding any FSA counter anions, the CFSC is free or essentially free of an anionicly charged compound. Without wishing to be bound by theory, compounds with anionic charges may bind with cationicly charged FSA.

### III. COUPLING AGENT

One aspect of the invention provides a coupling agent as an optional, but preferred, addition to the CFSC. In some embodiments of the invention, coupling agents may be used to achieve a phase-stable mixture. The diluent and the FSA are often immiscible at either the reaction temperature necessary for quatting or at room temperature. Not to be bound by theory, a coupling agents allows the diluent and FSA to remain miscible for optimal reaction conditions and to produce a homogeneous raw material.

In one embodiment, the coupling agent comprises, from a weight basis, at least about 0.1%, alternatively at least about 0.2%, 0.5%, 0.75%, 1%, 2%, 3%, 5%, 10%; but less than about 15%, alternatively less than about, 10%, 5%, or 1%; by weight of the CFSC.

In one embodiment, the coupling agent is chosen from partial esters of polyhydric alcohols. Preferred partial esters used in the present invention contain from about 8% to about 10% of free hydroxyl content by weight of coupling agent composition.

In one embodiment, the coupling agent is chosen from a polyhydric alcohol or polyol as herein previously described.

In a fourth embodiment, the coupling agent is chosen from, but not limited to, at least one of the following: glycerin (Glycerin Star produced by Procter & Gamble Chemicals) glycerol mono & di-stearate (GMS, Stepan GMS Pure produced by Stepan), glycerin derivative, or combinations thereof.

In one embodiment, the coupling agent is chosen from a nonionic surfactant, a block copolymer obtained by copolymerization of ethylene oxide and propylene oxide, or a combination thereof.

### A. Nonionic Surfactant

### 1. Alkyl or alkyl-aryl alkoxylated nonionic surfactants

In one embodiment, the nonionic surfactant comprises an alkyl or alkyl-aryl alkoxylated nonionic surfactant. Suitable alkyl alkoxylated nonionic surfactants are generally derived from saturated or unsaturated primary, secondary, and branched fatty alcohols, fatty acids, alkyl phenols, or alkyl aryl (e.g., benzoic) carboxylic acid, where the active hydrogen(s) is alkoxylated with ≦ about 30 alkylene, preferably ethylene, oxide moieties (e.g. ethylene oxide and/or propylene oxide). These nonionic surfactants for use herein preferably have from about 6 to about 22 carbon atoms on the alkyl or alkenyl chain, and are in either straight chain or branched chain configuration, preferably straight chain configurations having from about 8 to about 18 carbon atoms, with the alkylene oxide being present, preferably at the primary position, in average amounts of ≦ about 30 moles of alkylene oxide per alkyl chain, more preferably from about 5 to about 15 moles of alkylene oxide, and most preferably from about 8 to about 12 moles of alkylene oxide. Examples of alkyl alkoxylated surfactants with straight chains include Neodol® 91-8, 25-9, 1-9, 25-12, 1-9, and 45-13 from Shell, Plurafac® B-26 and C-17 from BASF, and Brij® 76 and 35 from ICI Surfactants. Examples of branched alkyl alkoxylated surfactants include Tergitol® 15-S-12, 15-S-15, and 15-S-20 from Union Carbide and Emulphogene® BC-720 and BC-840 from GAF. Examples of alkyl-aryl alkoxylated surfactants include Igepal® CO-620 and CO-710, from Rhone Poulenc, Triton® N-111 and N-150 from Union Carbide, Dowfax® 9N5 from Dow, Lutensol® AP9 and AP14, from BASF, and Alcohol Ethoxylate 25-9, Tomadol 25-9 produced by Tomah.

### 2. Alkyl or alkyl-aryl amine or amine oxide nonionic alkoxylated surfactants

In one embodiment, the nonionic surfactant comprises an alkyl or alkyl-aryl amine or amide oxide nonionic alkoxylated surfactant. Suitable alkyl alkoxylated nonionic surfactants with amine functionality are generally derived from saturated or unsaturated, primary, secondary, and branched fatty alcohols, fatty acids, fatty methyl esters, alkyl phenol, alkyl benzoates, and alkyl benzoic acids that are converted to amines, amine-oxides, and optionally substituted with a second alkyl or alkyl-aryl hydrocarbon with one or two alkylene oxide chains attached at the amine functionality each having 5. about 50 moles alkylene oxide moieties (e.g. ethylene oxide and/or propylene oxide) per mole of amine. The amine or amine-oxide surfactants for use herein have from about 6 to about 22 carbon atoms, and are in either straight chain or branched chain configuration, preferably there is one hydrocarbon in a straight chain configuration having about 8 to about 18 carbon atoms with one or two alkylene oxide chains attached to the amine moiety, in average amounts of ≦50 about moles of alkylene oxide per amine moiety, more preferably from about 5 to about 15 moles of alkylene oxide, and most preferably a single alkylene oxide chain on the amine moiety containing from about 8 to about 12 moles of alkylene oxide per amine moiety. Examples of ethoxylated amine surfactants include Berol® 397 and 303 from Rhone Poulenc and Ethomeens® C/20, C25, T/25, S/20, S/25 and Ethodumeens® T/20 and T25 from Akzo.

In one example, the compounds of the alkyl or alkyl-aryl alkoxylated surfactants and alkyl or alkyl-aryl amine and amine-oxide alkoxylated comprise the following general formula:

R¹ₘ—Y—[(R²—O)_{z}—H]ₚ

wherein each R¹ is selected from the group consisting of saturated or unsaturated, primary, secondary or branched chain alkyl or alkyl-aryl hydrocarbons; said hydrocarbon chain preferably having a length of from about 6 to about 22, more preferably from about 8 to about 18 carbon atoms, and even more preferably from about 8 to about 15 carbon atoms, preferably, linear and with no aryl moiety; wherein each R² is selected from the following groups or combinations of the following groups: —(CH₂)ₙ— and/or —[CH(CH₃)CH₂]—; wherein about 1<n≦5 about 3; Y is selected from the following groups: —O—; —N(A)_{q}—; —C(O)O—; —(O←)N(A)_{q}—; —B—R³—O—; —B—R³—N(A)_{q}—; —B—R³—C(O)O—; —B—R³—N(→O)(A)-; and mixtures thereof; wherein A is selected from the following groups: H; R¹; —(R²—O)_{z}—H; —(CH₂)ₓCH₃; phenyl, or substituted aryl, wherein 0≦x≦ about 3 and B is selected from the following groups: —O—; —N(A)—; —C(O)O—; and mixtures thereof in which A is as defined above; and wherein each R³ is selected from the following groups: R²; phenyl; or substituted aryl. The terminal hydrogen in each alkoxy chain can be replaced by a short chain C₁₋₄ alkyl or acyl group to “cap” the alkoxy chain. z is from about 5 to about 30. p is the number of ethoxylate chains, typically one or two, preferably one and m is the number of hydrophobic chains, typically one or two, preferably one and q is a number that completes the structure, usually one.

Preferred structures are those in which m=1, p=1 or 2, and 5≦z≦30, and q can be 1 or 0, but when p=2, q must be 0; more preferred are structures in which m=1, p=1 or 2, and 7≦z≦20; and even more preferred are structures in which m=1, p=1 or 2, and 9≦z≦12. The preferred y is 0.

In one embodiment, the nonionic surfactant is a methylcapped nonionic surfactant.

### B. Block Copolymers Obtained by Copolymerization of Ethylene Oxide and Propylene Oxide

In one embodiment, the coupling agent comprises a block copolymers obtained by copolymerization of ethylene oxide and propylene oxide. Suitable polymers include a copolymer having blocks of terephthalate and polyethylene oxide. More specifically, these polymers are comprised of repeating units of ethylene and/or propylene terephthalate and polyethylene oxide terephthalate at a preferred molar ratio of ethylene terephthalate units to polyethylene oxide terephthalate units of from about 25:75 to about 35:65, said polyethylene oxide terephthalate containing polyethylene oxide blocks having molecular weights of from about 300 to about 2000. The molecular weight of this polymer is in the range of from about 5,000 to about 55,000.

Another preferred polymer is a crystallizable polyester with repeat units of ethylene terephthalate units containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials Zelcon® 4780 (from DuPont) and Milease® T (from ICI).

Preferred polymers comprising the formula:

X—(OCH₂CH₂)ₙ—[O—C(O)—R¹—C(O)—O—R²)ᵤ—[O—C(O)—R¹—C(O)—O)—(CH₂CH₂O)ₙ—X (1)

in which X can be any suitable capping group, with each X being selected from the group consisting of H, and alkyl or acyl groups containing from about 1 to about 4 carbon atoms, preferably methyl, n is selected for water solubility and generally is from about 6 to about 113, preferably from about 20 to about 50, and u is critical to formulation in a liquid composition having a relatively high ionic strength. There should be very little material in which u is greater than 10. Furthermore, there should be at least 20%, preferably at least 40%, of material in which u ranges from about 3 to about 5.

The R¹ moieties are essentially 1,4-phenylene moieties. As used herein, the term “the R¹ moieties are essentially 1,4-phenylene moieties” refers to compounds where the R¹ moieties consist entirely of 1,4-phenylene moieties, or are partially substituted with other arylene or alkarylene moieties, alkylene moieties, alkenylene moieties, or mixtures thereof. Arylene and alkarylene moieties which can be partially substituted for 1,4-phenylene include 1,3-phenylene, 1,2-phenylene, 1,8-naphthylene, 1,4-naphthylene, 2,2-biphenylene, 4,4-biphenylene and mixtures thereof. Alkylene and alkenylene moieties which can be partially substituted include ethylene, 1,2-propylene, 1,4-butylene, 1,5-pentylene, 1,6-hexamethylene, 1,7-heptamethylene, 1,8-octamethylene, 1,4-cyclohexylene, and mixtures thereof.

For the R¹ moieties, the degree of partial substitution with moieties other than 1,4-phenylene should be such that the desired properties of the compound are not adversely affected to any great extent. Generally, the degree of partial substitution which can be tolerated will depend upon the backbone length of the compound, i.e., longer backbones can have greater partial substitution for 1,4-phenylene moieties. Usually, compounds where the R¹ comprise from about 50% to about 100% 1,4-phenylene moieties (from 0 to about 50% moieties other than 1,4-phenylene) are adequate. Preferably, the R¹ moieties consist entirely of (i.e., comprise 100%) 1,4-phenylene moieties, i.e., each R¹ moiety is 1,4-phenylene.

For the R² moieties, suitable ethylene or substituted ethylene moieties include ethylene, 1,2-propylene, 1,2-butylene, 1,2-hexylene, 3-methoxy-1,2-propylene and mixtures thereof. Preferably, the R² moieties are essentially ethylene moieties, 1,2-propylene moieties or mixture thereof. Surprisingly, inclusion of a greater percentage of 1,2-propylene moieties tends to improve the water solubility of the compounds.

Therefore, the use of 1,2-propylene moieties or a similar branched equivalent is desirable for incorporation of any substantial part of the polymer in the liquid fabric softener compositions. Preferably, from about 75% to about 100%, more preferably from about 90% to about 100%, of the R² moieties are 1,2-propylene moieties.

The value for each n is at least about 6, and preferably is at least about 10. The value for each n usually ranges from about 12 to about 113. Typically, the value for each n is in the range of from about 12 to about 43.

A more complete disclosure of these polymers is contained in European Patent Application 185,427.

Other preferred copolymers include surfactants, such as the polyoxypropylene/polyoxyethylene/polyoxypropylene (PO/EO/PO) reverse block polymers.

The copolymer can optionally contain propylene oxide in an amount up to about 15% by weight. Other preferred copolymer surfactants can be prepared by the processes described in U.S. Pat. No. 4,223,163.

Suitable block polyoxyethylene-polyoxypropylene polymeric compounds that meet the requirements described hereinbefore include those based on ethylene glycol, propylene glycol, glycerol, trimethylolpropane and ethylenediamine as initiator reactive hydrogen compound. Certain of the block polymer surfactant compounds designated PLURONIC® and TETRONIC® by the BASF-Wyandotte Corp., Wyandotte, Mich., are suitable in compositions of the invention.

A preferred copolymer contains from about 40% to about 70% of a polyoxypropylene/polyoxyethylene/polyoxypropylene block polymer blend comprising about 75%, by weight of the blend, of a reverse block copolymer of polyoxyethylene and polyoxypropylene containing 17 moles of ethylene oxide and 44 moles of propylene oxide; and about 25%, by weight of the blend, of a block copolymer of polyoxyethylene and polyoxypropylene initiated with trimethylolpropane and containing 99 moles of propylene oxide and 24 moles of ethylene oxide per mole of trimethylolpropane.

Other polymers useful herein include the polyethylene glycols having a molecular weight of from about 950 to about 30,000 which can be obtained from the Dow Chemical Company of Midland, Mich. Such compounds for example, have a melting point within the range of from about 30° C. to about 100° C., can be obtained at molecular weights of 1,450, 3,400, 4,500, 6,000, 7,400, 9,500, and 20,000. Such compounds are formed by the polymerization of ethylene glycol with the requisite number of moles of ethylene oxide to provide the desired molecular weight and melting point of the respective polyethylene glycol.

### IV. CFSC COMPRISING LOW LEVEL OF WATER

One aspect of the invention provides a CFSC comprising low levels of water. In one embodiment, the CFSC comprises less than about 6% water by weight of the CFSC, alternatively less than about 5%, 4%, 3%, 2%, 1%, 0.5%, 0.25%, 0.1%, or 0.01% water by weight of the CFSC. In one embodiment, the CFSC is free or essentially free of water. In another embodiment, the CFSC comprises at least 0.001% water by weight of the CFSC.

Another aspect of the invention provides a CFSC free or essentially free of a detersive surfactant. In one embodiment, the CFSC is free or essentially free of anionic detersive surfactant.

Yet another aspect of the invention provides for CSFC that is neither clear nor translucent. In one embodiment, the CFSC is opaque. In one embodiment, the CFSC is free or essentially free of a principle solvent comprising a Clog P of about −1 to about +1.6.

### V. METHODS OF MAKING CFSC

One aspect of the invention provides for a method of making a CFSC. Generally, the CFSC of the present invention is produced by combining a tertiary amine, diluent, and optionally a coupling agent in a glass pressure-rated vessel. The contents of the sealed reactor are exposed to nitrogen and heated above 100° C. An alkylating agent is introduced at a rate to maintain 40 psig pressure. Upon reaching a free amine target (e.g., of about 0.06 meq/g), the reactor is inerted with nitrogen.

It is important to maintain homogeneity of the reaction mixture to provide efficient and complete quaternization and thereby providing high yields. To achieve these high yields, the reaction mixture, in one embodiment, comprises a viscosity less than 5000 centipoise, preferably less than 4000 centipoise, more preferably 3000 centipoise, still more preferably 2000 centipoise. In this embodiment, the reaction mixture comprises a tertiary amine, diluent, optionally a coupling agent, and an alkylating agent. Non limiting examples of an alkylating agent include methyl chloride, dimethyl sulfate, methyl bromide, methyl iodide.

In one embodiment, the invention is directed to a method of making a flakable fabric conditioning composition by combining an esteramine, hydrogenated tallow, glycerol stearate, glycerine and alkylating with methyl chloride. The cooled reaction mixture is then flaked by various methods to yield the CFSC for later use.

### VI. FABRIC CARE COMPOSITION

Another aspect of the invention provides for a fabric care composition comprising a CFSC and water and methods of making and using the same. The fabric care composition is the composition that is ultimately used by the consumer.

In one embodiment, the fabric care composition comprises, on a weight basis, the CFSC from about 2% to about 98%, alternatively from about 10% to about 50%, alternatively 12% to about 25%, by weight of the fabric care composition.

In another embodiment, the fabric care composition comprises on a weight basis, the water from about 2% to about 98%, alternatively from about 15% to about 75%, alternatively 25% to about 50%, by weight of the fabric care composition.

In another embodiment, the fabric care composition comprises on a weight basis, the FSA from about 2% to about 20%, alternatively from about 3% to about 15% , alternatively from about 4% to about 10%, alternatively from about 5% to about 8%, by weight of the fabric care composition.

### A. Suds Suppressor

One aspect of the invention provides for a fabric care composition further comprising a suds suppressor. Suitable suds suppressors are disclosed (referred to as “suds suppressing systems”) in US 2003/0060390 A1, at paragraphs 65-77. A preferred suds suppressor is one comprising a silicone. A suitable example is Silfoam, SE90, SE39 PG, SE 39 from Wacker. In one embodiment, the fabric care composition comprises from about 0.01% to about 5% of a suds suppressor by weight of the fabric care composition.

### B. Cationic Starch

A second aspect of the invention provides for a fabric care composition further comprising a cationic starch. Cationic starches are disclosed in US 2004/0204337 A1. In one embodiment, the fabric care composition comprises from about 0.1% to about 7% of cationic starch by weight of the fabric care composition. In one embodiment, the cationic starch is HCP401 from National Starch.

### C. Scum Dispersant

In one aspect of the invention, the fabric care composition comprising scum dispersant. Suitable scum dispersants are described in US 2003/0126282 A1, paragraphs 89-90.

### D. Methods of Using Fabric Care Composition in a Single Rinse.

A third aspect of the invention provides for a method of softening a fabric comprising the steps of obtaining a fabric care composition of the present invention, adding to the fabric care composition to a first rinse bath solution, alternatively a single bath solution. For purposes of clarification, there is no intermediate rinsing step in a first rinse step or a single rinse step. In one embodiment, the method further comprises rinsing the fabric in the first or single rinse bath solution to which the fabric care composition was added. The rinse process may be by hand or by machine. Another embodiment of the invention provides for a kit comprising a fabric care composition of the present invention. Optionally, the kit comprises instructions for using the fabric care composition in a single rinse or first rinse context.

### VII. ADJUNCT INGREDIENTS

One aspect of the invention provides a CFSC and/or the fabric care composition to comprise at least one or more adjunct ingredients. Yet another aspect of the invention, provides CFSC and/or fabric care composition that is free or essentially free of one or more adjunct ingredient. In one embodiment, the CFSC is free or essentially free of all adjunct ingredients. The term “adjunct ingredient” includes: perfumes, dispersing agents, stabilizers, pH control agents, metal ion control agents, colorants, brighteners, dyes, odor control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof.

### VIII. METHOD OF MAKING A FABRIC CARE COMPOSITION.

One aspect of the invention provides for a method of making a fabric care composition comprising the steps of obtaining a CFSC composition, in one embodiment a solid CFSC composition, hydrating (i.e., adding water) to the CFSC composition to form an aqueous dispersion, agitating the aqueous dispersion to form the fabric care composition.

Generally, the CFSC is added to the water or water seat slowly to form an aqueous dispersion. The water is typically deionized water. In one embodiment, the temperature of the water is at about or above the melt transition temperature of the CFSC. The slurry is agitated to facilitate the melting and/or hydrating of the CFSC. Non-limiting examples of achieving agitation include the use of a turbine impellar, or a high shear mixer (e.g., IKA Ultra Turrax). Adjunct ingredients may be added anytime. In one embodiment, electrolyte is added to the slurry. In another embodiment, perfume or thickener is added to a fabric care composition, preferably when the fabric care composition is at about ambient temperature (i.e., after cooling if necessary). Adjunct ingredients may be added to the slurry or fabric care composition with agitation.

In another embodiment, a molten liquid CFSC of the present invention is obtained and prepared to a fabric care composition according to a method described in U.S. Pat. No. 5,545,340.

Another aspect of the invention provides a method of making a fabric care composition, alternatively a single rinse fabric care composition, comprising the steps: (a) manufacturing a CFSC at a first site, alternatively wherein the CFSC comprises a flashpoint above 100° C.; (b) containing the CFSC in a container, in one embodiment, the container is one where no heat is applied to the CFSC contained in the container; (c) transporting the container containing the CFSC to a second site. In one embodiment, the method further comprises the step of hydrating the CFSC to form an aqueous dispersion. In yet another embodiment, adjunct ingredients may be added to the aqueous dispersion and/or currently with the hydrating step.

The first site may be a first country, such as the U.S., and the second site may be a second country, such as China. Alternatively, the first site may be a first city in a first country and the second site may be a second city in the same first country, i.e., two different cities within the same country. Alternatively, the first site and second sites may be different buildings at the same manufacturing facility.

Transportation can be done by rail, truck, and/or ship.

In one embodiment, the containers of the present invention are a type of container that do not hold explosive or flammable materials. In another embodiment, the containers of the present invention are a type that do not have a means of generating heat (e.g., to keep contents in the container in a molten state). In yet another embodiment, the CFSC is removed from the container without the use of heat.

The present invention is directed, in part, to a CFSC that comprises low water and a high flashpoint thereby providing a surprising economically way of shipping materials that can ultimately be made to fabric conditioning compositions. Thus, one aspect of the present invention provides a method of making a fabric care composition that omits the use of high capital equipment at the second site. The term “high capital equipment” means equipment that cannot be moved or placed on a skid. Examples of high capital include permanent storage tanks and the fixed piping associated with such tanks. Fixed infrastructure is another example of high capital equipment.

### IX. EXAMPLES

### Example 1

### An Example of a CFSC is Prepared

Esteramine T7: To a 5 L flask is added T7 Fatty Acid (2891.3 g, 10.51 mol) and phosphorous acid (3.92 g, 0.05 mol). Stirring is initiated and methyldiethanolamine (835.3 g, 7.01 mol) is added under nitrogen sweep. Mixture is heated to 190° C. and water is removed via distillation. Upon reaching the free fatty acid target of 0.35 meq/g, vacuum is applied to −600 mmHg. Reaction conditions are held until target final acidity (0.055 meq/g) is reached to produce esteramine T7.

To a 4 L glass pressure-rated vessel is added Esteramine 17 (1796.8 g, 3.50 mol) with stirring. Hard Tallow (175.03 g), Stepan GMS pure (16.40 g) and glycerine, 99% (30.21 g) are added. The reactor is sealed, inerted with nitrogen and heated to 105° C. Methyl chloride (175.40 g, 3.47 mol) is added at a rate to maintain 40 psig pressure. Upon reaching the free amine target (0.06 meq/g), the reactor is inserted with nitrogen.

The product is flaked by placing the molten mixture onto a chilled drum of a drum dryer. The solid product is collected and crushed into the flaked form.

### Example 2

### Single Rinse Fabric Care Compositions are Provided

| | EXAMPLES | | | | | |
|---|---|---|---|---|---|---|
| INGREDIENTS | A | B | C | D | E | F |
| FSA ^{a} | 6.5% | 4.875% | 6.5% | 7.25% | 7.5% | 5% |
| FSA ^{b} | 0% | 1.625% | 0% | 0% | 0% | 0% |
| Diluent ^{c} | 0.4-1.5% | 0.4-1.5% | 0.4-1.5% | 0.4-1.5% | 0.4-1.5% | 0.4-1.5% |
| Monoglycerol Stearate | 0.2-1% | 0.2-1% | 0.2-1% | 0.2-1% | 0.2-1% | 0.2-1% |
| Glycerine | 0-1% | 0-1% | 0-1% | 0-1% | 0-1% | 0-1% |
| Suds Suppressor ^{d} | 0.1% | 0.1% | 0.1% | 0.1% | 0.13% | 0.1% |
| Cationic Starch ^{e} | 0% | 0% | 0.7% | 0% | 0% | 1.0% |
| Perfume | 0.8-1.5% | 0% | 0.8-1.5% | 0.8-1.5% | 0.8-1.5% | 0.8-1.5% |
| Rheology Modifier ^{f} | 0% | 0% | 0% | 0% | 0% | 0.2% |
| Calcium Chloride | 0.1-0.15% | 0.1-0.15% | 0.1-0.15% | 0.1-0.15% | 0.1-0.15% | 0.1% |
| Preservative ^{g} | 0.025% | 0.025% | 0.025% | 0.025% | 0.0125% | 0.025% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.025% | 0.023% | 0.025% | 0.025% | 0.021% | 0.020% |
| Deionized Water | Balance | Balance | Balance | Balance | Balance | Balance |

^{a} Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N- dimethyl ammonium chloride and N-(stearoyl-oxy-ethyl) N,-hydroxyethyl N,N dimethyl ammonium chloride.
^{b} N,N-di(tallowoyloxyethyl)-N,N-dimethylammonium chloride.
^{c} Hard tallow triglyceride, tallow triglyceride, or palm triglyceride
^{d} SE39 from Wacker
^{e} Cationic starch based on common maize starch or potato starch, containing 25% to 95% amylose and a degree of substitution of from 0.02 to 0.09. Available from Cerestar under the trade name C*BOND ® or under the trade name CATO ® A2 from National Starch or under the trade name HCP 401 available from National Starch.
^{f} Alcogum L-520
^{g} gluteraldehyde.

| | EXAMPLES | | | | | |
|---|---|---|---|---|---|---|
| INGREDIENTS | G | H | I | J | K | L |
| FSA ^{a} | 5% | 5% | 4% | 4% | 4% | 4% |
| Diluent ^{c} | 0.35-1.15% | 0.35-1.15% | 0.3-1% | 0.3-1% | 0.3-1% | 0.3-1% |
| Coupling Agent ^{d} | 0-0.065% | 0-0.065% | 0-0.055% | 0-0.055% | 0-0.055% | 0-0.055% |
| Suds Suppressor ^{e} | 0.075% | 0.075% | 0.075% | 0.075% | 0.075% | 0.075% |
| Cationic Starch ^{f} | 0% | 0% | 0% | 0.45% | 0.2% | 0.3% |
| Perfume | 0.2-1% | 0.2-1% | 0.2-1% | 0.2-1% | 0.2-1% | 0.2-1% |
| Rheology Modifier ^{g} | 0.28% | 0.3% | 0.36% | 0% | 0% | 0.36% |
| Calcium Chloride | 0% | 0% | 0% | 0.01% | 0.05% | 0.02% |
| Preservative ^{h} | 0.0125% | 0.0125% | 0.0125% | 0.0125% | 0.0125% | 0.0125% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.02% | 0.02% | 0.02% | 0.02% | 0.02% | 0.02% |
| Deionized Water | Balance | Balance | Balance | Balance | Balance | Balance |

^{g} Rheovis CSP

| | EXAMPLES | | | | | |
|---|---|---|---|---|---|---|
| INGREDIENTS | M | N | O | P | Q | R |
| FSA ^{a} | 0% | 5.5% | 0% | 0% | 0% | 0% |
| FSA ⁱ | 5.5% | 0% | 5.5% | 6% | 5% | 4% |
| Diluent ^{c} | 0.35-1.15% | 0.35-1.15% | 0.35-1.15% | 0.4-1.38 | 0.35-1.15% | 0.3-1% |
| Coupling Agent ^{d} | 0-0.065% | 0-0.065% | 0-0.065% | 0-0.08% | 0-0.065% | 0-0.055% |
| Suds Suppressor ^{e} | 0.07% | 0.1% | 0.06-0.13% | 0.9% | 0.8% | 0.11% |
| Cationic Starch ^{f} | 0.6% | 0.5% | 0-0.5% | 0.5% | 0.3% | 0.2% |
| Perfume | 0.8-1.5% | 0.8-1.5% | 0% | 0.8-1.5% | 0.8-1.5% | 0.8-1.5% |
| Rheology Modifier ^{g} | 0% | 0% | 0.39% | 0% | 0.45% | 0.45% |
| Calcium Chloride | 0.01-0.02% | 0.01-0.05% | 0.01-0.05% | 0.01-0.05% | 0.01-0.05% | 0.01-0.05% |
| Preservative ^{h} | 0.0125% | 0.0125% | 0.0125% | 0.0125% | 0.0125% | 0.0125% |
| Dye | 0.003%-0.03% | 0.003%-0.03% | 0.003%-0.03% | 0.003%-0.03% | 0.003%-0.03% | 0.003%-0.03% |
| Hydrochloric Acid | 0.025% | 0.025% | 0.025% | 0.025% | 0.025% | 0.025% |
| Deionized Water | Balance | Balance | Balance | Balance | Balance | Balance |

ⁱ Reaction product of Fatty acid with Methyldiethanolamine and quaternized with Methylchloride, resulting in a 2.44:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.

### Example 3

### Fabric Care Composition is Made from a Solid CFSC

A solid CFSC is grinded to a small particle (e.g <10 mm³). The fabric care composition is made by adding the ground CFSC to a beaker containing 80° C. deionized water, HCl and CaCl₂ with stirring. The mixer is stirred for 10 minutes. Perfume and dye are then added and mixture is cooled in an ice bath to 25° C.

### Example 4

### Fabric Care Composition is Made from a Solid CFSC

1. Deionized water is heated to 80C+/−5C in an insulated beaker.
2. Add an aqueous cationic starch premix, prepared by adding 10-20% of the cationic starch to deionized water and heating the aqueous slurry to 90° C. for 30 minutes, to the above mixture with mixing (turbine impeller at 25-500 RPM).
3. Grind the solid CFSC coarsely in a coffee grinder and add over a period of 3-10 minutes with mixing (wall scraper impeller at 10-50 RPM) and milling (Ultra Turrax T25 Mill at 2000 to 10000 RPM) to form an aqueous dispersion containing 15 to 25% CFSC by weight.
4. Add over 1-5 minutes each of the following: ambient deionized water, 2N HCl, 25% calcium chloride aqueous solution, to the above mixture with mixing (turbine impeller at 25-500 RPM) to reduce the CFSC concentration to target level.
5. Add perfume and mix (turbine impeller at 25-500 RPM) for 5-20 minutes.
6. Cool the above composition to 25C+/−5C with stirring in an ice bath.
7. Add suds supressor, preservative with mixing (turbine impeller at 25-500 RPM) for 2-10 minutes,
8. Add rheology modifier, and dye with mixing (turbine impeller at 25-500 RPM) for 20-60 minutes.

### Example 5

### Further Single Rinse Fabric Care Compositions are Provided

| | EXAMPLES | | | | | |
|---|---|---|---|---|---|---|
| INGREDIENTS | A | B | C | D | E | F |
| FSA ^{a} | 5.0% | 5.0% | 7.1% | 8.0% | 8.0% | 8.0% |
| Diluent ^{b} | 0.45% | 0.45% | 0.63% | 0.71% | 0.71% | 0.71% |
| Monoglycerol Stearate | 0.06% | 0.06% | 0.08% | 0.09% | 0.09% | 0.09% |
| Glycerine | 0.06% | 0.06% | 0.08% | 0.09% | 0.09% | 0.09% |
| Suds Suppressor ^{c} | 0.08% | 0.08% | 0.12% | 0.12% | 0.20% | 0.20% |
| Cationic Starch ^{d} | 0.0% | 0.63% | 0.89% | 0.0% | 0.0% | 1.0% |
| Perfume | 0.50%-0.80% | 0.50%-0.80% | 0.80%-1.30% | 0.80%-1.30% | 1.5%-3.0% | 1.5%-3.0% |
| Rheology Modifier ^{e} | 0.30%-0.60% | 0.20%-0.50% | 0.1%-0.3% | 0.1%-0.4% | 0.0%-0.3% | 0.0%-0.3% |
| Calcium Chloride | 0.05% | 0.06% | 0.09% | 0.08% | 0.08% | 0.08% |
| Preservative ^{f} | 0.03% | 0.03% | 0.03% | 0.03% | 0.03% | 0.03% |
| Scum Inhibitor ^{h} | 0.20% | 0.20% | 0.32% | 0.32% | 0.60% | 0.60% |
| Dye | 0.003% | 0.003% | 0.003% | 0.003% | 0.003% | 0.003% |
| Hydrochloric Acid | 0.02% | 0.025% | 0.036% | 0.03% | 0.03% | 0.03% |
| Deionized Water | Balance | Balance | Balance | Balance | Balance | Balance |

^{a} Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{b} Hard tallow triglyceride, tallow triglyceride, or palm triglyceride
^{c} SE39 from Wacker
^{d} Cationic starch based on common maize starch or potato starch, containing 25% to 95% amylose and a degree of substitution of from 0.02 to 0.09. Available from Cerestar under the trade name C*BOND ® or under the trade name CATO ® A2 from National Starch or under the trade name HCP 401 available from National Starch.
^{e} Rheovis CSP from Ciba Specialty
^{f} gluteraldehyde.
^{h} Cetyl-stearyl Alcohol E 80 from Huntsman

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A concentrated fabric softening composition (“CFSC”) comprising from about 60% to about 98% of a fabric softening active (“FSA”) and a diluent;
wherein the FSA comprises a quaternary ammonium compound, wherein the quaternary ammonium compound comprises a monoester and a diester, wherein the monester comprises from about 10% to about 50% by the total FSA weight; and wherein the diester comprises from about 15% to about 80% by the total FSA weight;
wherein the diluent provides the CFSC to have a 80% of its melting enthalpy above about 40° C. as determined by a differential scanning calorimetry;
wherein the concentrated softening composition comprises less than 6% water by weight of the CFSC.

2. The composition according to claim 1, wherein the diluent is chosen from at least one of the following: an alkylester or polyester, alkylamide or polyamide, fatty acid, hydrogenated tallow fat, hydrogenated tallow fatty acid, hydrogenated coconut oil, hydrogenated palm stearine, hydrogenated soy oil, ethylene glycol distearate, hard soy sucrose ester, cetyl palmitate, pentaerythritol tetracaprylate/tetracaprate, or combinations thereof.

3. The composition of claim 1, wherein the diluent is chosen from a fatty acid, triglyceride, hydrogenated triglyceride, or combination thereof.

4. The composition of claim 3, wherein the diluent comprises from about 10% to about 25% fatty acid by weight of the CFSC.

5. The composition of claim 3, wherein the diluent comprises from about 2% to about 25% triglyceride by weight of the CFSC.

6. The composition of claim 3, wherein the CFSC is free of water.

7. The composition of claim 6, wherein the CFSC is essentially free of an anionic charged compound.

8. The composition of claim 7, wherein the CFSC is essentially free of an adjunct ingredient.

9. The composition of claim 4, wherein the CFSC further comprises a coupling agent, wherein the coupling agent is chosen from a nonionic surfactant or a block copolymer obtained by copolymerization of ethylene oxide and propylene oxide.

10. The composition of claim 9, wherein the diluent comprises from about 2% to about 25% triglyceride by weight of the CFSC,
wherein the coupling agent comprises from about 0.5 to about 5% of the nonionic surfactant by weight of the CFSC; and
wherein the CFSC is essentially free of water; and
wherein the CFSC is essentially free of an adjunct ingredient.

11. The composition of claim 9, wherein the diluent comprises from about 2% to about 25% triglyceride,
wherein the coupling agent comprises 0.5-5% of the block copolymer obtained by copolymerization of ethylene oxide and propylene oxide; and
wherein the CFSC is essentially free of water; and
wherein the CFSC is essentially free of an adjunct ingredient.

12. A method of making a fabric care composition comprising the steps:
(a) manufacturing a concentrated fabric softening composition (CFSC) in a first site, wherein the CFSC comprises a flashpoint above 100° C.;
(b) containing the CFSC in a container; wherein no heat is applied to the CFSC contained in the container;
(c) transporting the container containing the CFSC to a second site.

13. The method of claim 12, further comprising the step of hydrating the CFSC to form an aqueous dispersion.

14. The method of claim 13, wherein the first site is location inside the territory of a first country and wherein the second site is a territory outside of the first country.

15. The method of claim 14, wherein the CFSC is essentially free of water; and wherein in the fabric care composition is a single rinse fabric care composition.

16. The method of claim 15, wherein the CFSC is essentially free of an adjunct ingredient.

17. The method of claim 16, wherein the method omits the use of high capital equipment at the second geography.

18. The method of claim 17, wherein the method further comprises the step of adding a suds suppressor to the aqueous dispersion.

19. The method of claim 17, wherein the method further comprises the step of adding at least three adjunct ingredients to the aqueous dispersion.

20. A concentrated fabric softening composition (“CFSC”) comprising:
(a) from about 75% to about 98% of a fabric softening active by weight of the CFSC;
(b) from about 0.05% to about 15% glycerin or a glycerin derivative by weight of the CFSC;
(c) from about 6% to about 10% of a triglyceride by weight of the CFSC;
(d) less than 1% water composition by weight of the CFSC
(e) free of adjunct ingredients.
